(19) United States
(12) Patent Application Publication
(10) Pub. No.: US 2019/0162986 A1
(43) Pub. Date: May 30, 2019

(54) POLARIZATION SPLITTING AND COMBINING APPARATUS

(71) Applicant: ELECTRONICS AND TELECOMMUNICATIONS RESEARCH INSTITUTE, Daejeon (KR)

(72) Inventors: Joong-Seon Choe, Daejeon (KR); Chun Ju Youn, Daejeon (KR); Heasin Ko, Daejeon (KR); Kap-Joong Kim, Daejeon (KR); Byung-seok Choi, Daejeon (KR)

(73) Assignee: ELECTRONICS AND TELECOMMUNICATIONS RESEARCH INSTITUTE, Daejeon (KR)

(21) Appl. No.: 16/184,495

(22) Filed: Nov. 8, 2018

(30) Foreign Application Priority Data
Nov. 28, 2017 (KR) 10-2017-0160960

(51) Int. Cl. G02F 1/01; G02F 1/225; H04L 9/08

(52) U.S. Cl. CPC G02F 1/0136; G02F 1/225; G02F 2001/217; G02F 2203/07; H04L 9/0858

(57) ABSTRACT

Provided is an apparatus configured to split light into a plurality of polarizations, the apparatus including an input waveguide configured to receive the light, a first interferometer configured to split the light into a first polarization and a second polarization, and a second interferometer configured to split the light into a third polarization and a fourth polarization, wherein the first interferometer and the second interferometer are connected in parallel, the first interferometer comprises a first output waveguide configured to output the first polarization, and a second output waveguide configured to output the second polarization, and the second interferometer comprises a third output waveguide configured to output the third polarization, and a fourth output waveguide configured to output the fourth polarization.

### CROSS-REFERENCE TO RELATED APPLICATIONS

This U.S. non-provisional patent application claims priority under 35 U.S.C. § 119 of Korean Patent Application No. 10-2017-0160960, filed on Nov. 28, 2017, the entire contents of which are hereby incorporated by reference.

### BACKGROUND

The present disclosure herein relates to an apparatus for splitting a light signal into a plurality of polarizations or combining a plurality of polarizations into one light signal.

A quantum cryptography communication attracts attention for communication security. The quantum cryptography communication is a communication technology in which security is enhanced using characteristics of a quantum that is not replicable. In other words, a communication performed on the basis of information on the unique quantum mechanical characteristics (e.g. a vibration direction of a photon) of a photon is called as the quantum cryptography communication.

A communication protocol for the quantum cryptography communication may be realized on the basis a polarization. For example, the communication protocol may deliver information using four kinds of polarizations including a vertical polarization, a horizontal polarization, a diagonal polarization, and an anti-diagonal polarization.

A plurality of polarizations may be delivered from a transmitter to a receiver through communication paths (e.g. an optical communication network or a free space). Accordingly, a function for splitting a light signal into a plurality of polarizations may be required in the quantum cryptography communication.

### SUMMARY

The present disclosure provides an apparatus for splitting a light signal into a plurality of polarizations using a Mach-Zehnder interferometer.

However, technical issues of the present disclosure are not limited to those described above and other technical issues will be clearly understood by those skilled in the art from the following description.

An embodiment of the inventive concept provides an apparatus configured to split light into a plurality of polarizations, the apparatus including: an input waveguide configured to receive the light; a first interferometer configured to split the light into a first polarization and a second polarization; and a second interferometer configured to split the light into a third polarization and a fourth polarization, wherein the first interferometer and the second interferometer are connected in parallel, the first interferometer includes a first output waveguide configured to output the first polarization, and a second output waveguide configured to output the second polarization, and the second interferometer includes a third output waveguide configured to output the third polarization, and a fourth output waveguide configured to output the fourth polarization.

In an embodiment of the inventive concept, an apparatus configured to split light into a plurality of polarizations includes: an input waveguide configured to receive the light; a first interferometer configured to split the light into a first polarization and a second polarization; a second interferometer configured to split the light into a third polarization and a fourth polarization; and a wave plate disposed between an input terminal of the second interferometer and the input waveguide and configured to change a polarization state of the light input to the second interferometer, wherein the first interferometer includes a first output waveguide configured to output the first polarization and a second output waveguide configured to output the second polarization, and the second interferometer includes a third output waveguide configured to output the third polarization and a fourth output waveguide configured to output the fourth polarization.

In an embodiment of the inventive concept, an apparatus configured to combine a plurality of polarizations includes: a first interferometer configured to output first light to which a first polarization and a second polarization are combined; a second interferometer configured to output second light to which a third polarization and a fourth polarization are combined; and an output waveguide configured to combine and output the first light and the second light, wherein the first interferometer and the second interferometer are connected in parallel, the first interferometer includes a first input waveguide configured to receive the first polarization and a second input waveguide configured to receive the second polarization, and the second interferometer includes a third input waveguide configured to receive the third polarization and a fourth input waveguide configured to receive the fourth polarization.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 illustrates a conceptual diagram of a quantum cryptography communication according to an embodiment of the inventive concept;

FIG. 2 illustrates a block diagram of a polarization splitting apparatus according to an embodiment of the inventive concept;

FIG. 3 illustrates a block diagram of another polarization splitting apparatus according to an embodiment of the inventive concept;

FIG. 4A illustrates a detailed block diagram of another polarization splitting apparatus according to an embodiment of the inventive concept;

FIG. 4B illustrates a multimode interference device that splits a light signal into a plurality of polarizations and outputs the plurality of polarizations;

FIG. 5A illustrates a detailed block diagram of another polarization splitting apparatus according to an embodiment of the inventive concept;

FIG. 5B illustrates a perspective view of the polarization splitting apparatus of FIG. 5A, which is realized according to an embodiment of the inventive concept;

FIG. 6A illustrates a detailed block diagram of another polarization splitting apparatus according to an embodiment of the inventive concept; and

FIG. 6B illustrates a perspective view of the polarization splitting apparatus of FIG. 6A, which is realized according to an embodiment of the inventive concept.

### DETAILED DESCRIPTION

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

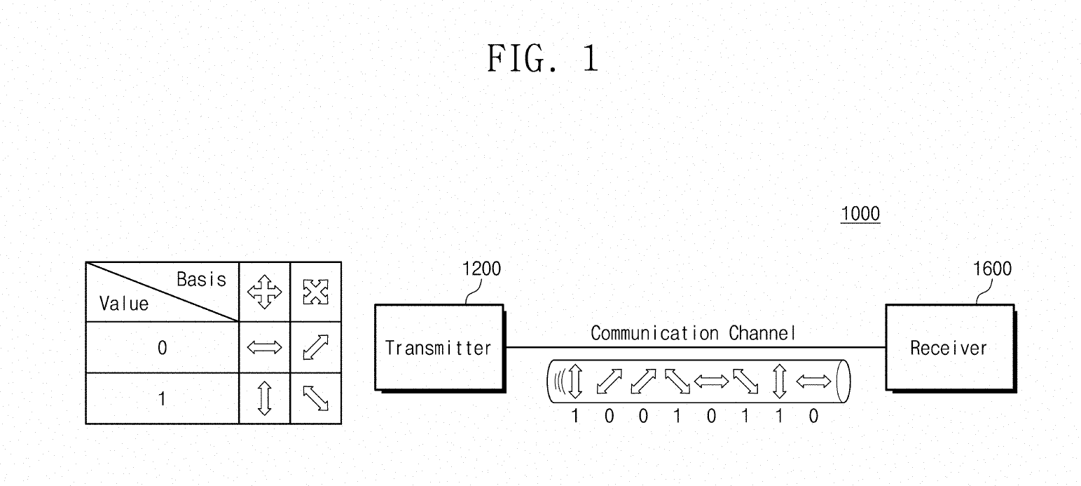

FIG. 1 illustrates a system in which a quantum cryptography communication is performed.

A transmitter 1200 may deliver a light signal generated from a light source to a receiver 1600 through a communication channel. For example, the transmitter 1200 may encode information on a polarization of a photon to deliver the encoded information to the receiver 1600 through the communication channel.

The transmitter 1200 according to an embodiment may select an orthogonal basis and encode a vertical polarization (i.e., 0 degree polarization) into ‘0’, and a horizontal polarization (i.e., 90 degree polarization) into ‘1’. Alternatively, the transmitter 1200 selects a diagonal basis to encode a diagonal polarization (i.e., 45 degree polarization) into ‘0’ and an anti-diagonal polarization (i.e., 135 degree polarization) into ‘1’.

The receiver may use the orthogonal basis or the diagonal basis to decode a signal received from the transmitter 1200.

The system 1000 may analyze information on the bases used for encoding by the transmitter 1200 and information on the bases used for decoding by the receiver 1600 to maintain communication security by distributing the analyzed result to the transmitter 1200 and the receiver 1600.

In other words, the quantum cryptography communication is a communication technology based on a fact that a photon, which shows a quantum effect, is not replicable. A safe communication between the transmitter 1200 and the receiver 1600 may be performed using a fact that the characteristics of the photon change when hacking is attempted outside the system 100.

The system 1000 may use the four polarizations including the vertical, horizontal, diagonal and anti-diagonal polarizations. The four polarizations may be delivered from the transmitter 1200 to the receiver 1600 through the communication channel. Accordingly, the system 1000 may require a function for splitting the light signal into the plurality of polarizations or for combining a plurality of polarizations into one light signal.

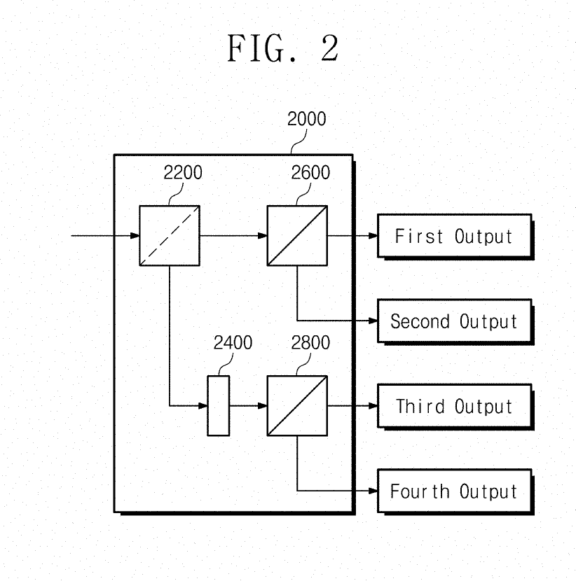

FIG. 2 illustrates a block diagram of a polarization splitting apparatus according to an embodiment of the inventive concept.

The polarization splitting apparatus 2000 may split incident light into four polarizations. The four polarizations may mean a horizontal polarization, a vertical polarization, a diagonal polarization, and an anti-diagonal polarization. The four polarizations may be respectively output through a first output unit, a second output unit, a third output unit, and a fourth output unit. According to an embodiment, each of the first to fourth output units may include a diode.

The polarization splitting apparatus 2000 may include a beam splitter 2200, a wave plate 2400, and two polarization beam splitter 2600 and 2800.

The beam splitter 2200 may make the incident light travel along different paths. The beam splitter 2200 according to an embodiment may be realized with a translucent mirror. The incident light to the beam splitter 2200 may be reflected by the translucent mirror and travel along a first path, or penetrate the translucent mirror and travel along a second path. For example, the incident light to the beam splitter 2200 may proceed to the polarization beam splitter 2600 or the polarization beam splitter 2800.

The polarization beam splitter 2600 or 2800 may split the incident light into the plurality of polarizations and output the plurality of polarizations. For example, the polarization beam splitter 2600 or 2800 may mean an optical element including a birefringence crystal.

The polarization beam splitter 2600 according to an embodiment may split light received from the beam splitter 200 into a horizontal polarization and a vertical polarization. The horizontal polarization may be output through the first output unit and the vertical polarization may be output through the second output unit.

The wave plate 2400 may be located between the beam splitter 2200 and the polarization beam splitter 2800. The wave plate 2400 may change a polarization state of incident light. For example, the wave plate 2400 may change a diagonal polarization or an anti-diagonal polarization input from the beam splitter 200 to a horizontal polarization or a vertical polarization. The wave plate 2400 according to an embodiment may be a half-wave plate or a quarter-wave plate, but is not limited thereto.

Accordingly, the polarization beam splitter 2800 may split incident light from the wave plate 2400 into a horizontal polarization and a vertical polarization, and output the horizontal polarization and the vertical polarization. The horizontal polarization may be output through the third output unit, and the vertical polarization may be output through the fourth output unit.

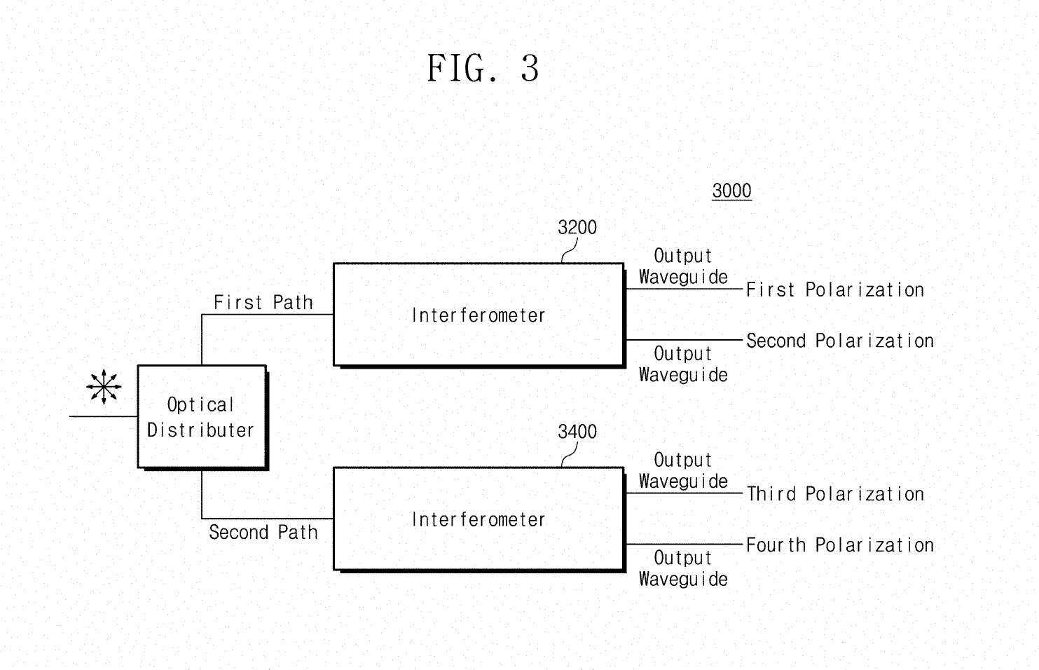

FIG. 3 illustrates a block diagram of another polarization splitting apparatus according to an embodiment of the inventive concept.

A polarization splitting apparatus 3000 may include two interferometers 3200 and 3400 connected in parallel.

An interferometer is an element for dividing incident light from an identical light source into two or more parts and generating differences between traveling paths thereof, and then allowing an observer to observe an interference phenomenon generated when the two or more parts of the light meet together. For example, light incident to the interferometer is distributed into two paths, the distributed lights may travel along different paths (e.g. waveguides) and generate a phase difference. The two lights having the phase difference may meet together to generate an interference phenomenon.

The interferometer 3200 and the other interferometer 3400 may be connected in parallel. The interferometer 3200 and the other interferometer 3400 are connected to an input waveguide of the polarization splitting apparatus 3000, and make light incident from the input waveguide travel therealong.

For example, the light incident to the polarization splitting apparatus 3000 may be distributed and output to the interferometer 3200 and the other interferometer 3400. Light incident to the polarization splitting apparatus 3000 may be distributed by an optical distributor and travel along a first path and a second path.

The light traveling along the first path is output to the interferometer 3200 and the light traveling along the second path is output to the other interferometer 3400.

Hereinafter, the optical distributor may mean an optical element that makes an incident light travel along a plurality of paths, but according to an embodiment, may mean a waveguide itself (e.g. a Y-shaped waveguide) in a form that may distribute light to travel along a plurality of paths.

Each of the interferometer 3200 and the other interferometer 3400 may include two output waveguides that may output two split polarizations. The light along the interferometer 3200 may be split into a first polarization and a second polarization. The first polarization and the second polarization may be output through different output waveguides. In addition, the light along the other interferometer 3400 may be split into a third polarization and a fourth polarization. The third polarization and the fourth polarization may be output through different output waveguides.

For example, the light along the interferometer 3200 may be distributed to and travel along two waveguides (may be referred to as connection waveguides) to generate a phase difference. The interferometer 3200 may split the light into the first polarization and the second polarization using the phase difference generated by the lights traveling along the two different waveguides.

The other interferometer 3400 may perform the same operation as that of the interferometer 3200. For example, light having traveled along the interferometer 3400 may be distributed to and travel along two waveguides (may be referred to as connection waveguides) to generate a phase difference. The other interferometer 3400 may split the light into the third polarization from the fourth polarization using the phase difference generated by lights having traveled along the two different waveguides.

According to an embodiment, each of the interferometer 3200 and the other interferometer 3400 may be a Mach-Zehnder interferometer having two arms and two output waveguides. The two arms included in each of the interferometer 3200 and the other interferometer 3400 may correspond to two connection waveguides for generating the phase difference. Hereinafter, the ‘interferometer’ may mean the ‘Mach-Zehnder interferometer’.

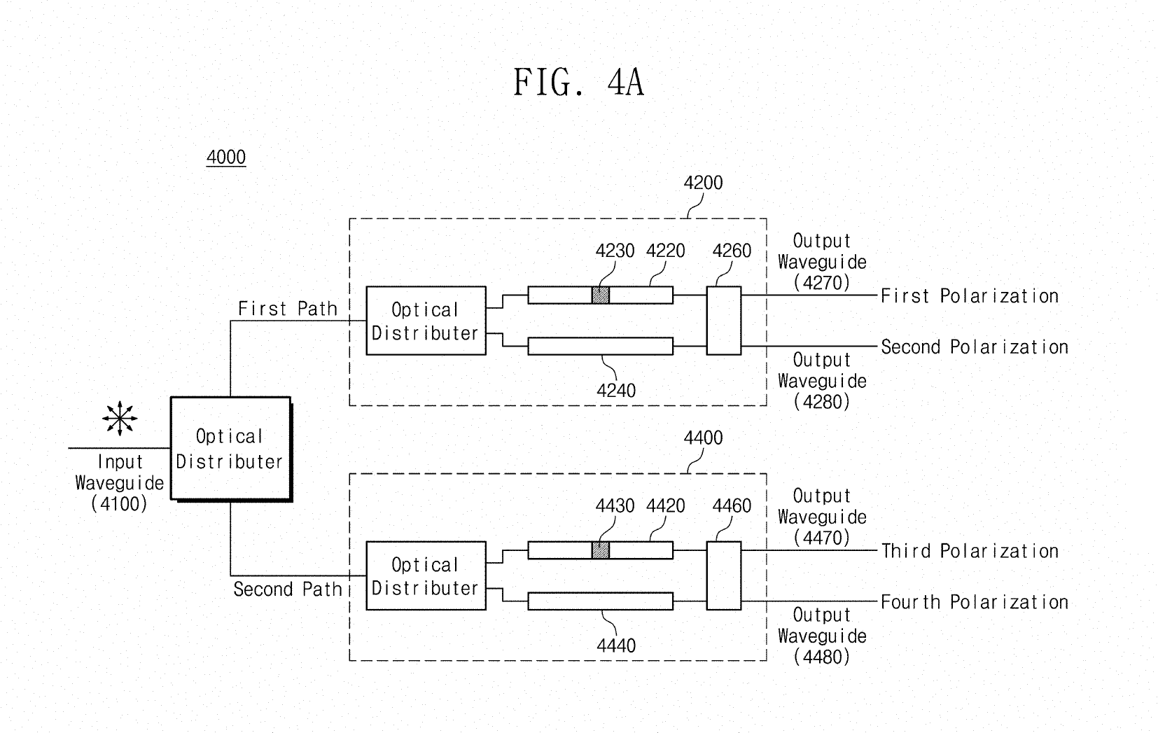

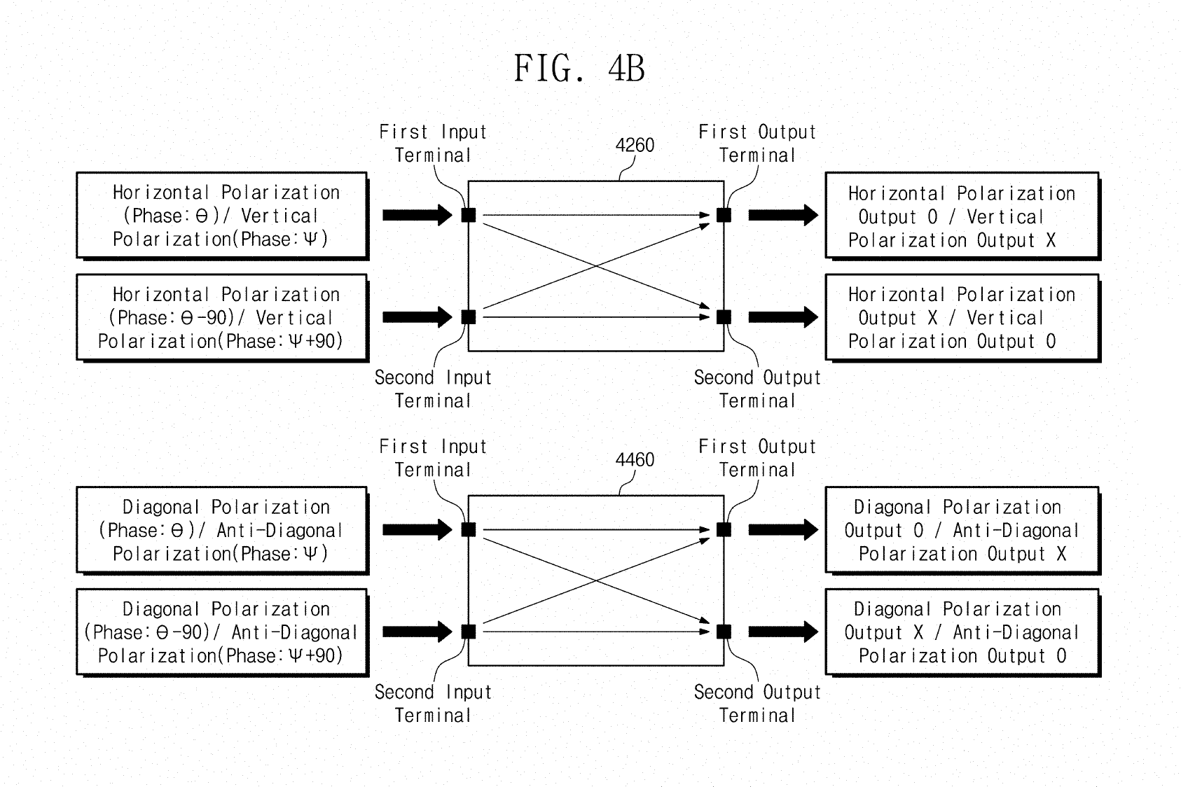

FIG. 4A illustrates a detailed block diagram of another polarization splitting apparatus according to an embodiment of the inventive concept.

A polarization splitting apparatus 4000 of FIG. 4A represents a detailed embodiment of the polarization splitting apparatus 3000 of FIG. 3. Accordingly, the above description about the polarization splitting apparatus 3000 of FIG. 3 may be also applied to the polarization splitting apparatus 4000 of FIG. 4.

The polarization splitting apparatus 4000 may include two interferometers 4200 and 4400 connected in parallel. The polarization splitting apparatus 4000 may split light incident from an input waveguide 4100 into a first polarization, a second polarization, a third polarization, and a fourth polarization, and output the same.

The interferometer 4200 may split light having traveled along a first path into the first polarization and the second polarization. The first polarization may be output through an output waveguide 4270 and the second polarization may be output through another output waveguide 4280.

The other interferometer 4400 may split light having traveled along the second path into the third polarization and the fourth polarization. The third polarization may be output through an output waveguide 4470 and the fourth polarization may be output through another output waveguide 4480.

The interferometer 4200 may include two arms 4220 and 4240, and a multimode interference device 4260. The two arms 4220 and 4240 may allow light distributed to the interferometer 4200 to travel therealong. At least one of the two arms 4220 and 4240 may include a birefringence material for changing the phase of the light. For example, the arm 4220 may include a birefringence material for changing the phase of the light traveling therealong.

The other interferometer 4400 may include two arms 4420 and 4440 and a multimode interference device 4460. The two arms 4420 and 4440 may allow light distributed to the other interferometer 4400 to travel therealong. At least one of the two arms 4420 and 4440 may include a birefringence material for changing the phase of the light. For example, the arm 4420 may include a birefringence material 4430 for changing the phase of the light traveling therealong.

For an operation of the other interferometer 4200, the phase of the light traveling along the arm 4220 may be changed by a birefringence material 4230. For example, the phase of light traveling along the arm 4220 may be delayed by about 90 degrees by the birefringence material 4230. Accordingly, the phase of a vertical polarization traveling along the arm 4220 may precede, by about 90 degrees, the phase of a vertical polarization traveling along the arm 4240. In addition, the phase of a horizontal polarization traveling along the arm 4240 may precede, by about 90 degrees, the phase of a horizontal polarization traveling along the arm 4220. Accordingly, a phase difference may be generated between the light traveling along the arm 4220 and the light traveling along the arm 4240. The light traveling along the arm 4220 and the light traveling along the arm 4240 may be input to the multimode interference device 4260 for polarization splitting.

For an operation of the interferometer 4400, the phase of light traveling along the arm 4420 may be changed by a birefringence material 4430. For example, the phase of light traveling along the arm 4420 may be delayed by about 90 degrees by the birefringence material 4430. Accordingly, the phase of an anti-diagonal polarization traveling along the arm 4420 may precede, by about 90 degrees, the phase of an anti-diagonal polarization traveling along the arm 4440. In addition, the phase of a diagonal polarization traveling along the arm 4440 may precede, by about 90 degrees, the phase of a diagonal polarization traveling along the arm 4420. Accordingly, a phase difference may be generated between the light traveling along the arm 4420 and the light traveling along the arm 4440. The light traveling along the arm 4420 and the light traveling along the arm 4440 may be input to the multimode interference device 4460 for polarization splitting.

Each of the multimode interference device 4260 and the other multimode interference device 4460 may be 2×2 coupler having two input terminals and two output terminals.

For an operation of the multimode interference device in relation to FIG. 4B, a first input terminal of the multimode interference device 4260 may receive a horizontal polarization of which phase is Θ, and a second input terminal may receive a horizontal polarization of which phase is Θ−90.

While proceeding to the second output terminal, the light input from the first input terminal and having the horizontal polarization of phase Θ may have a phase delayed by about 90 degrees than the light proceeding to the first output terminal. For example, when the phase of the light at the first input terminal is Θ, the phase of the light arrives at the second output terminal may become Θ+90. The light input from the second input terminal and having the horizontal polarization of phase Θ−90 may proceed to the second output terminal without a phase change. Accordingly, the horizontal polarization (the phase: Θ+90) delivered from the first input terminal and the horizontal polarization (the phase: Θ−90) delivered from the second input terminal may be destructive to each other at the second output terminal. Consequently, the horizontal polarization is not output from the second output terminal and may be output only from the first output terminal.

While proceeding to the first output terminal, light input from the second input terminal and having a vertical polarization of phase ψ+90 may have a phase delayed by about 90 degrees than light proceeding to the first output terminal.

For example, when the phase of the vertical polarization at the second input terminal is ψ+90, the phase of the vertical polarization arriving at the first output terminal may be ψ+180. The light input from the first input terminal and having a vertical polarization of phase ψ may proceed to the first output terminal without a phase change. Accordingly, the vertical polarization (the phase: ψ+180) delivered from the second input terminal and the vertical polarization (the phase: ψ) delivered from the first input terminal may be destructive to each other at the first output terminal. Consequently, the vertical polarization is not output from the first output terminal and may be output only from the second output terminal.

Consequently, a multimode interference device 4260 may perform splitting into the horizontal polarization and the vertical polarization on the basis of the phase difference between the light received from the first input terminal and the light received from the second input terminal.

The multimode interference device 4460 may performing splitting into and output a diagonal polarization and an anti-diagonal polarization from two diagonal polarizations having a phase difference and from two anti-diagonal polarizations having a phase difference. An operation in which the multimode interference device 4460 splits light into a diagonal polarization and an anti-diagonal polarization is identical to that in the multimode interference device 4260, and thus a detailed description thereabout will be omitted.

Referring to FIG. 4A again, a wave plate (not shown) may be connected to an input terminal of any one between the two interferometers 4200 and 4400. The wave plate may change a polarization state of incident light. For example, the wave plate may change a diagonal polarization or an anti-diagonal polarization to a horizontal polarization or a vertical polarization. Accordingly, the light in which a polarization state is changed by the wave plate may travel along any one of the two interferometers 4200 and 4400.

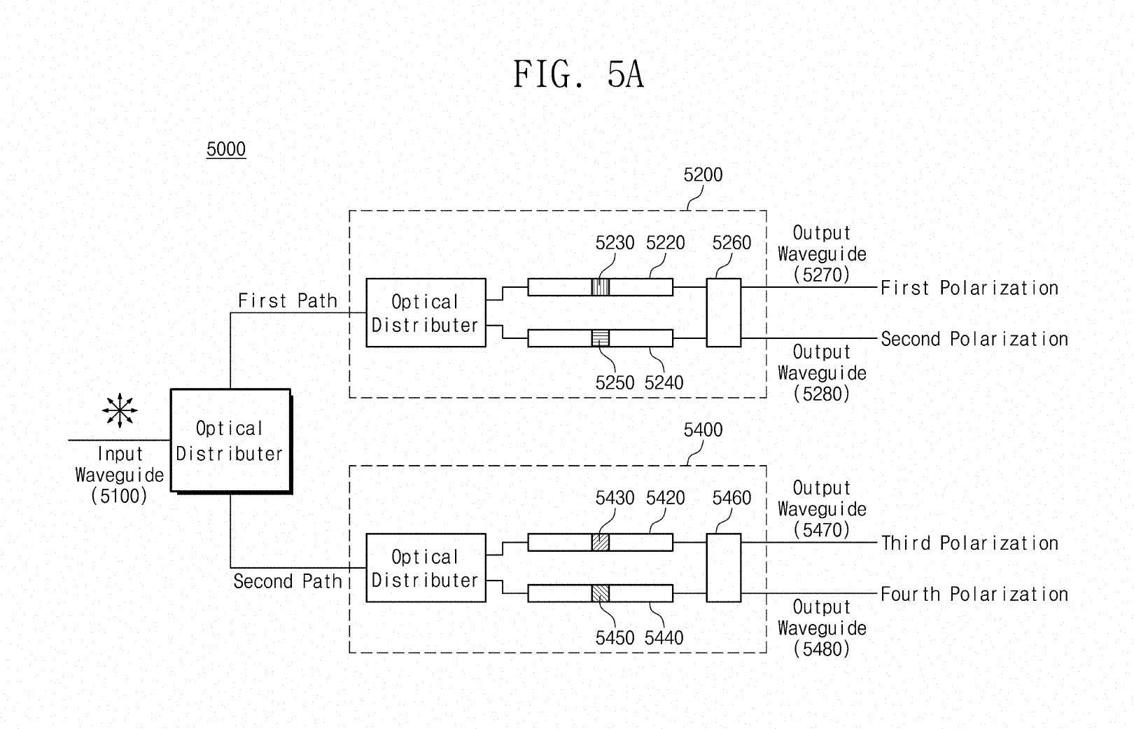

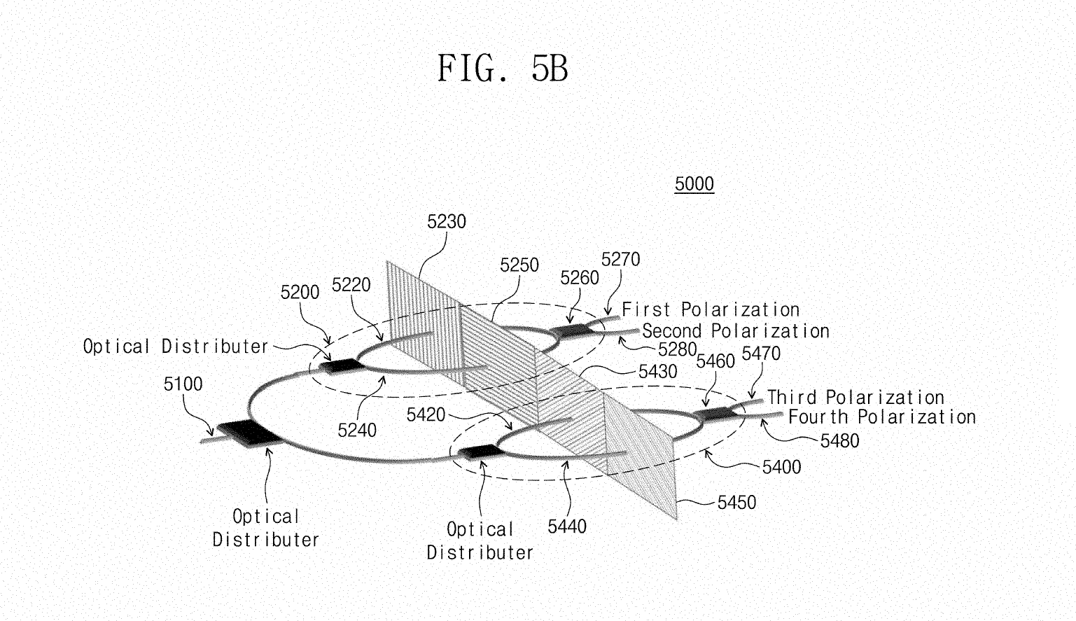

FIG. 5A illustrates a detailed block diagram of a polarization splitting apparatus according to an embodiment of the inventive concept.

A polarization splitting apparatus 5000 is different from the polarization splitting apparatus 4000 in that the polarization splitting apparatus 5000 uses a wave plate rather than a birefringence material in order to generate a phase difference between lights traveling along arms of an interferometer. According to an embodiment, the lengths of an arm 5220 and an arm 5240 may be the same. According to an embodiment, the lengths of the arm 5420 and the arm 5440 may be the same.

The light input through the input waveguide 5110 may be distributed to an interferometer 5200 and another interferometer 5400.

According to an embodiment, the arm 5220 of the interferometer may include (be inserted with) a quarter-wave plate 5230 of which an optical axis is vertical, and the arm 5240 may include (be inserted with) a quarter-wave plate 5240 of which an optical axis is horizontal. The quarter-wave plate 5230 may change the phase of light traveling along the arm 5220 and the quarter-wave plate 5240 may change the phase of light traveling along the arm 5240.

A horizontal polarization passing through the quarter-wave plate 5230 and another horizontal polarization passing through the quarter-wave plate 5250 may arrive at a multimode interference device 5260. According to an embodiment, the phase of the horizontal polarization passing through the quarter-wave plate 5230 and arriving may have a difference by about 90 degrees from that of the horizontal polarization passing through the quarter-wave plate 5250 and arriving.

A vertical polarization passing through the quarter-wave plate 5230 and another vertical polarization passing through the quarter-wave plate 5250 may arrive at the multimode interference device 5260. According to an embodiment, the phase of the vertical polarization passing through the quarter-wave plate 5230 and arriving may have a difference by about 90 degrees from that of the vertical polarization passing through the quarter-wave plate 5250 and arriving.

The multimode interference device 5260 may output the vertical polarization through an output waveguide 5270, and output the horizontal polarization through an output waveguide 5280.

According to an embodiment, an arm 5420 of the other interferometer 5400 may include (be inserted with) a quarter-wave plate 5430 of which an optical axis is diagonal, and an arm 5430 of the interferometer 5400 may include (be inserted with) a quarter-wave plate 5450 of which an optical axis is anti-diagonal. The quarter-wave plate 5430 may change the phase of light traveling along the arm 5420, and the quarter-wave plate 5440 may change the phase of light traveling along the arm 5440.

The diagonal polarization passing through the quarter-wave plate 5430 and the anti-diagonal polarization passing through the quarter-wave plate 5430 may arrive at the multimode interference device 5460. According to an embodiment, the phase of the diagonal polarization passing through the quarter-wave plate 5430 and arriving may have a difference by about 90 degrees from that of the diagonal polarization passing through the quarter-wave plate 5450 and arriving.

The multimode interference device 5460 may output the diagonal polarization through an output waveguide 5470, and output the anti-diagonal polarization through an output waveguide 5480.

FIG. 5B illustrates a perspective view of the polarization splitting apparatus of FIG. 5A, which is realized according to an embodiment of the inventive concept.

The configurations and connections of elements of the polarization splitting apparatus 5000 may be substantially identical to those described in relation to FIG. 5A, and thus the overlapping descriptions may be omitted hereinafter.

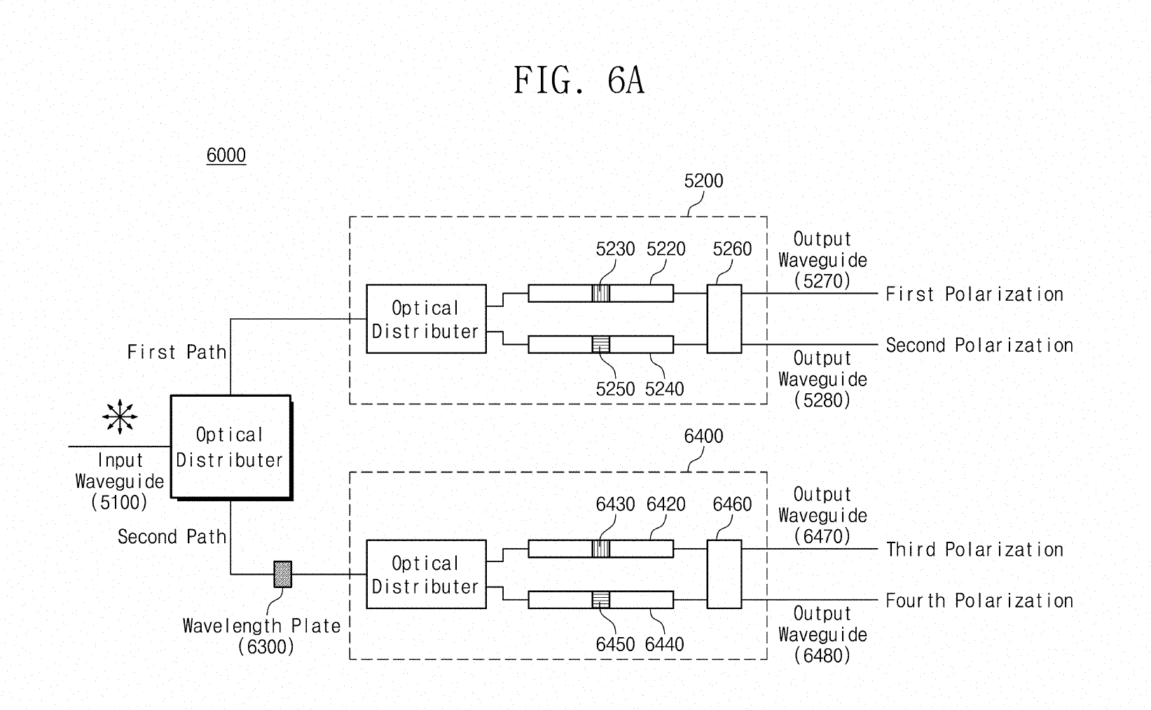

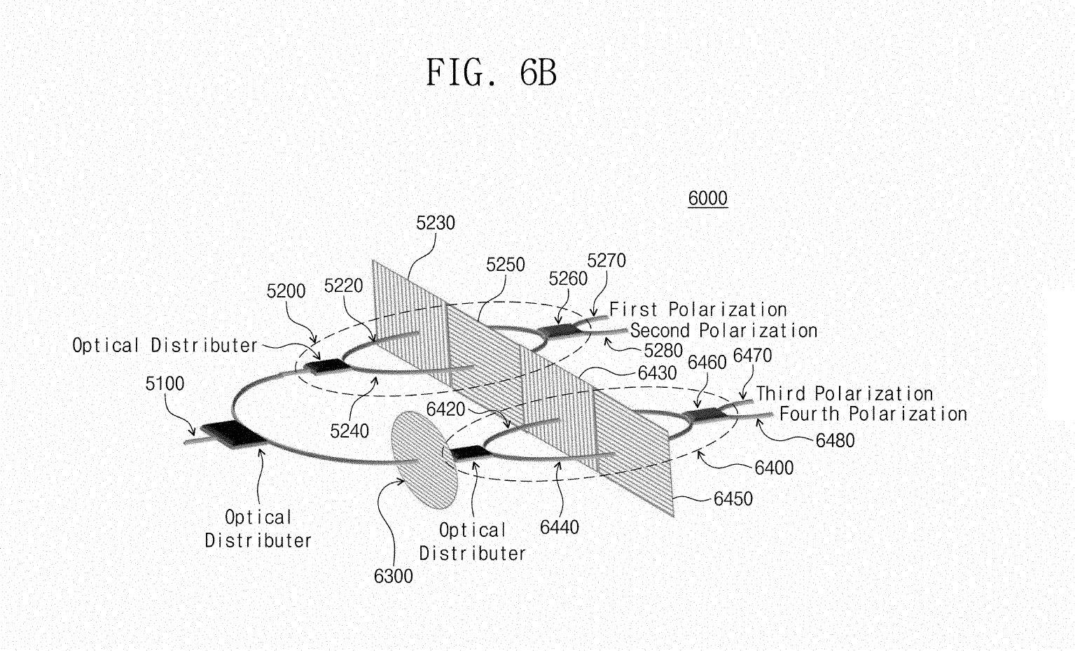

FIG. 6A illustrates a detailed block diagram of another polarization splitting apparatus according to an embodiment of the inventive concept.

A polarization splitting apparatus 6000 is different from the polarization splitting device 5000 of FIG. 5A in that an interferometer 6400 is used instead of the interferometer 5400 and a wave plate 6300 may be positioned between an input terminal of the interferometer 6400 and an input waveguide 5100. When the cross-section of the waveguide of the interferometer is rectangular instead of being circular, a polarization direction of a diagonal polarization or an anti-diagonal polarization may rotate and accordingly, it may be hard to perform polarization splitting.

Accordingly, the polarization splitting apparatus 6000 may use the wave plate 6300 to change the diagonal polarization or the anti-diagonal polarization into a horizontal polarization or a vertical polarization, and allow the horizontal polarization or the vertical polarization to travel along the interferometer 6400.

The wave plate 6300 may change a polarization state of light. For example, the wave plate 6300 may change the diagonal polarization or the anti-diagonal polarization into the horizontal polarization or the vertical polarization.

Accordingly, the horizontal polarization and the vertical polarization generated by the wave plate 6300 may travel along the interferometer 6400. The wave plate 6300 may be a half-wave plate or a quarter-wave plate.

For example, the wave plate 6300 may be a half-wave plate of which an optical axis is inclined by about 22.5 or about 67.5 degrees, but is not limited thereto.

Unlike the interferometer 5400 of FIG. 5A, an arm 6420 of the interferometer 6400 may include (be inserted with) a quarter-wave plate 6430 of which an optical axis is vertical, and an arm 6440 may include (be inserted with) a quarter-wave plate 6450 of which an optical axis is horizontal. In other words, since the diagonal polarization or the anti-diagonal polarization may be changed into the horizontal polarization or the vertical polarization by the wave plate 6300, the quarter-wave plate 6430 and the quarter-wave plate 6450 may be used for performing splitting into the horizontal polarization and the vertical polarization.

The multimode interference device 6460 may split light having traveled along the arm 6420 and arrived and light having traveled along the arm 6440 and arrived into the vertical polarization and the horizontal polarization. The multimode interference device 6460 may output the vertical polarization through an output waveguide 6470 and the horizontal polarization through an output waveguide 6480.

FIG. 6B illustrates a perspective view of the polarization splitting apparatus of FIG. 6A, which is realized according to an embodiment of the inventive concept.

The configurations and connections of elements of the polarization splitting apparatus 5000 may be substantially identical to those described in relation to FIG. 6A, and thus the overlapping descriptions may be omitted below.

Each of the polarization splitting apparatuses described in relation to FIGS. 3 to 6B may also operate as a polarization combining apparatus. When polarizations are respectively input to output waveguides of the polarization splitting apparatus, light to which to which the polarizations are combined may be output from an input waveguide.

For example, when, for the polarization splitting apparatus 4000 of FIG. 4A, a horizontal polarization is input to the output waveguide 4270, a vertical polarization is input to the output waveguide 4280, a diagonal polarization is input into the output waveguide 4470, and an anti-diagonal polarization is input into the output waveguide 4480, light to which the four polarizations are combined may be output through the input waveguide 4100. In this case, the interferometer 4200 may output first light to which the horizontal polarization and the vertical polarization are combined, the interferometer 4400 may output second light to which the diagonal polarization and the anti-diagonal polarization are combined. The first light and the second light may be combined in the input waveguide 4100. In other words, one light signal to which the horizontal polarization, the vertical polarization, the diagonal polarization, and the anti-diagonal polarization are combined may be output from the input waveguide 4100.

In other words, when any one of the polarization combining apparatuses described in relation to FIGS. 3 to 6B is used as an apparatus for combining polarizations, output waveguides through which the polarizations are output are used as waveguides for receiving polarization inputs, and an input waveguide for receiving input light may be used as a waveguide through which light to which the polarizations are combined is output.

According to exemplary embodiments of the present disclosure, miniaturization and performance stabilization of a transmitter and a receiver for a quantum cryptography communication may be accomplished by realizing a polarization splitting apparatus and a polarization combining apparatus using two Mach-Zehnder interferometers connected in parallel.

The above description is intended to provide exemplary configurations and operation in order to implement the present disclosure. The above description just illustrates the technical spirit of the present disclosure and various modifications and transformations can be made by those skilled in the art without departing from an essential characteristic of the present disclosure. Moreover, it should be understood that the present disclosure covers various techniques which can be readily modified and embodied based on the above-described example embodiments.

What is claimed is:

1. An apparatus configured to split light into a plurality of polarizations, the apparatus comprising:
an input waveguide configured to receive the light;
a first interferometer configured to split the light into a first polarization and a second polarization; and
a second interferometer configured to split the light into a third polarization and a fourth polarization, wherein
the first interferometer and the second interferometer are connected in parallel,
the first interferometer comprises a first output waveguide configured to output the first polarization, and a second output waveguide configured to output the second polarization, and
the second interferometer comprises a third output waveguide configured to output the third polarization, and a fourth output waveguide configured to output the fourth polarization.

2. The apparatus of claim 1, wherein
the first interferometer splits the light input thereto into the first polarization and the second polarization based on a phase difference generated by allowing the light to travel along different paths, and
the second interferometer splits the light input thereto into the third polarization and the fourth polarization based on a phase difference generated by allowing the light to travel along different paths.

3. The apparatus of claim 1, wherein
the first interferometer is a Mach-Zehnder interferometer comprising a first arm and a second arm, and
the second interferometer is a Mach-Zehnder interferometer comprising a third arm and a fourth arm.

4. The apparatus of claim 3, wherein
the first interferometer is further configured to generate a difference between a phase of the light traveling along the first arm and a phase of the light traveling along the second arm, and
the second interferometer is further configured to generate a difference between a phase of the light traveling along the third arm and a phase of the light traveling along the fourth arm.

5. The apparatus of claim 3, wherein
the first arm comprises a birefringence material for changing a phase of the light traveling along the first arm, and
the third arm comprises a birefringence material for changing a phase of the light traveling along the third arm.

6. The apparatus of claim 3, wherein
the first arm comprises a first wave plate configured to change a phase of the light traveling along the first arm,
the second arm comprises a second wave plate configured to change a phase of the light traveling along the second arm,
the third arm comprises a third wave plate configured to change a phase of the light traveling along the third arm, and
the fourth arm comprises a fourth wave plate configured to change a phase of the light traveling along the fourth arm.

7. The apparatus of claim 6, wherein
the first wave plate is a quarter-wave plate of which an optical axis is vertical,
the second wave plate is a quarter-wave plate of which an optical axis is horizontal,
the third wave plate is a quarter-wave plate of which an optical axis is diagonal, and
the fourth wave plate is a quarter-wave plate of which an optical axis is anti-diagonal.

8. The apparatus of claim 3, wherein
the first interferometer comprises a multimode interference device configured to perform splitting into the first polarization and the second polarization from the light traveling along the first arm and the light traveling along the second arm, and
the second interferometer comprises a multimode interference device configured to perform splitting the third polarization and the fourth polarization from the light traveling along the third arm and the light traveling along the fourth arm.

9. The apparatus of claim 1, wherein
the first polarization is a vertical polarization, the second polarization is a horizontal polarization, the third polarization is a diagonal polarization, and the fourth polarization is an anti-diagonal polarization.

10. An apparatus configured to split light into a plurality of polarizations, the apparatus comprising:
an input waveguide configured to receive the light;
a first interferometer configured to split the light into a first polarization and a second polarization;
a second interferometer configured to split the light into a third polarization and a fourth polarization; and
a wave plate disposed between an input terminal of the second interferometer and the input waveguide and configured to change a polarization state of the light input to the second interferometer, wherein
the first interferometer comprises a first output waveguide configured to output the first polarization and a second output waveguide configured to output the second polarization, and
the second interferometer comprises a third output waveguide configured to output the third polarization and a fourth output waveguide configured to output the fourth polarization.

11. The apparatus of claim 10, wherein the wave plate is configured to change a diagonal polarization or an anti-diagonal polarization to a vertical polarization or a horizontal polarization.

12. The apparatus of claim 10, wherein the wave plate is a half-wave plate of which an optical axis is inclined by about 22.5 degrees or about 66.5 degrees.

13. The apparatus of claim 10, wherein
the first interferometer is a Mach-Zehnder interferometer comprising a first arm and a second arm, and
the second interferometer is a Mach-Zehnder interferometer comprising a third arm and a fourth arm.

14. The apparatus of claim 13, wherein
the first interferometer is configured to generate a difference between a phase of the light traveling along the first arm and a phase of the light traveling along the second arm, and
the second interferometer is configured to generate a difference between a phase of the light traveling along the third arm and a phase of the light traveling along the fourth arm.

15. The apparatus of claim 13, wherein
the first arm comprises a first wave plate configured to change a phase of the light traveling along the first arm,
the second arm comprises a second wave plate configured to change a phase of the light traveling along the second arm,
the third arm comprises a third wave plate configured to change a phase of the light traveling along the third arm, and
the fourth arm comprises a fourth wave plate configured to change a phase of the light traveling along the fourth arm,
wherein the first wave plate and the third wave plate are respectively quarter-wave plates of which optical axes are vertical, and
the second wave plate and the fourth wave plate are respectively quarter-wave plates of which optical axes are horizontal.

16. The apparatus of claim 10, wherein
the first polarization and the third polarization are a vertical polarization, and
the second polarization and the fourth polarization are a horizontal polarization.

17. An apparatus configured to combine a plurality of polarizations, the apparatus comprising:
a first interferometer configured to output first light to which a first polarization and a second polarization are combined;
a second interferometer configured to output second light to which a third polarization and a fourth polarization are combined; and
an output waveguide configured to combine and output the first light and the second light, wherein
the first interferometer and the second interferometer are connected in parallel,
the first interferometer comprises a first input waveguide configured to receive the first polarization and a second input waveguide configured to receive the second polarization, and
the second interferometer comprises a third input waveguide configured to receive the third polarization and a fourth input waveguide configured to receive the fourth polarization.
